(19) United States
(12) Patent Application Publication
(10) Pub. No.: US 2025/0113791 A1
(43) Pub. Date: Apr. 10, 2025

(54) PLANT WATERING SYSTEM

(71) Applicant: Sharon Whiton Olson, Green Valley, AZ (US)

(72) Inventor: Sharon Whiton Olson, Green Valley, AZ (US)

(21) Appl. No.: 18/527,748

(22) Filed: Dec. 4, 2023

Related U.S. Application Data
(60) Provisional application No. 63/588,055, filed on Oct. 5, 2023.

(51) Int. Cl. A01G 27/00

(52) U.S. Cl. CPC A01G 27/006

(57) ABSTRACT

A plant watering system is provided. The system is comprised of at least one container that houses at least one liquid, such as but not limited to water. The water can be frozen inside the container, wherein the container can then be used in at least one method of use that involves placing the container at an angle in the soil of a plant. As a result, the water inside the container melts gradually in order to water the plant over time. In one method of use, a user can also add additives for plant growth/health prior to freezing.

### CROSS-REFERENCE TO RELATED APPLICATION

The present application claims priority to, and the benefit of, U.S. Provisional Application No. 63/588,055, which was filed on Oct. 5, 2023, and is incorporated herein by reference in its entirety.

### FIELD OF THE INVENTION

The present invention relates generally to the field of plant watering. More specifically, the present invention relates to a plant water system that uses a container with frozen liquid and a method of using the container to water a plant over an extended period of time. Accordingly, the present disclosure makes specific reference thereto. Nonetheless, it is to be appreciated that aspects of the present invention are also equally applicable to other like applications, devices, and methods of manufacture.

### BACKGROUND

Watering plants on a consistent basis plays a pivotal role in ensuring optimal plant growth and well-being. In certain environments, especially those characterized by excessively dry desert climates, the natural moisture available to plants is often insufficient. In these conditions, plants may require additional hydration to prevent wilting, dehydration, or even death.

However, for many individuals the demands of daily life can make it challenging to dedicate adequate time to water their plants. Said individuals may find it difficult to provide water to their plants multiple times throughout the day, as the climate might demand.

Further, while regular watering is crucial, there exists a fine balance to maintain. Overwatering or providing a plant with an excessive amount of water in a single instance can be harmful to a plant. More specifically, it can lead to waterlogged soil which can hinder the plant's root system and potentially stunt the plant's growth or cause root rot.

Therefore, there exists a long-felt need in the art for an improved plant watering system. There also exists a long-felt need in the art for a plant watering system that eases the responsibility of plant owners. More specifically, there exists a long-felt need in the art for a plant watering system that allows a plant owner to water a plant over time without the need to water the plant on multiple occasions. There also exists a long-felt need in the art for a plant watering system that allows a plant owner to water a plant over time without the need to water the plant on multiple occasions wherein the system also ensures a plant has enough water in dry climates. In addition, there exists a long-felt need in the art for a plant watering system that allows a plant owner to water a plant over time without the need to water the plant on multiple occasions, wherein the system also ensures a plant has enough water in dry climates and prevents overwatering of the plant.

The subject matter disclosed and claimed herein, in one embodiment thereof, comprises a plant watering system. The system is comprised of at least one container that houses at least one liquid, such as but not limited to water. The water can be frozen inside the container, wherein the container can then be used in at least one method of use that involves placing the container at an angle in the soil of a plant. As a result, the water inside the container melts gradually in order to water the plant over time. In one method of use, a user can also add additives for plant growth/health prior to freezing.

In this manner, the plant watering system of the present invention accomplishes all the forgoing objectives and provides an improved plant watering system. More specifically, the system eases the responsibility of plant owners by allowing a plant owner to water a plant over time without the need to water the plant on multiple occasions. Further, the system also ensures a plant has enough water in dry climates. In addition, the system prevents overwatering of the plant.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plant watering system comprised of a container used to water plants and at least two methods of using the container to water plants. During use, the system allows a user to water plants in a manner that does not require repeated manual watering over a short period of time.

The container is preferably made from a plastic (such as but not limited to BPA-free plastic), glass, or aluminum material. The container is also preferably transparent or semi-transparent to allow a user to see the liquid contents of the container while using the system. The container is preferably green to blend into a surrounding plant, but may be any color in the art in order to do so.

The container holds a liquid, such as but not limited to water, that is used to water a plant over an extended period of time. To allow a user to see how much water is placed into the container, the container may be comprised of at least one fill line which indicates how much water should be placed into the container. The container is also comprised of at least one spout that can be placed into soil at an angle that facilitates easy insertion of the spout into soil.

The container is received by at least one storage basket. The basket may be any structure designed to receive the container such that the container can be placed inside a freezer (to freeze the water inside the container). In one embodiment, the basket is comprised of at least one individual receiving area, such as but not limited to an opening, a recessed area, etc. that receives the container in a vertical position and prevents movement of the container.

The present invention is also comprised of a method of using the device. First, a device is provided comprised of a container comprised of a fill line. Then, the container can be filled with a liquid, such as but not limited to water, up to the fill line. Next, the container can be placed in a freezer (or frozen by any other means) until the liquid is frozen. In one embodiment, the container can be placed in the basket wherein the basket can then be placed into a freezer until the liquid is frozen. Then, the container can be removed and placed into a soil of a plant such that a spout of the container penetrates the soil at an angle between 0 and 180 degrees. As a result, the liquid inside the container will slowly unfreeze over time and melt into the soil to water the plant gradually in an autonomous manner.

The present invention is also comprised of a second method of using the device. First, a device is provided comprised of a container comprised of a fill line. Then, the container can be filled with a liquid, such as but not limited to water, up to (or below) the fill line. Then, at least one additive can be added to the liquid in the container. The additive aids in plant growth and may be comprised of, but is not limited to a water-soluble fertilizer, a liquid fertilizer, a seaweed extract, a fish emulsion, a compost tea, a humic acid, a fulvic acid, a bacteria, a mycorrhizae, a vermicompost leachate, a molasses, an Epsom salt (magnesium sulfate), a calcium solution, an iron chelate, a silicon solution, an amino acid, a proteins, a vitamin, an enzyme solution, or a pH adjuster. Next, the container can be placed in a freezer until the liquid is frozen (or otherwise freeze the liquid). In one embodiment, the container can be placed in the basket wherein the basket can then be placed into a freezer (or frozen by any other means) until the liquid is frozen. Then, the container can be removed and placed into a soil of a plant such that a spout of the container penetrates the soil at an angle between 0 and 180 degrees. As a result, the liquid and additive mix inside the container will slowly unfreeze over time and melt into the soil to water the plant gradually in an autonomous manner.

Accordingly, the plant watering system of the present invention is particularly advantageous as it provides an improved plant watering system. More specifically, the system eases the responsibility of plant owners by allowing a plant owner to water a plant over time without the need to water the plant on multiple occasions. Further, the system also ensures a plant has enough water in dry climates. In addition, the system prevents overwatering of the plant. In this manner, the plant watering system overcomes the limitations of existing plant watering devices, systems, and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of a container of one potential embodiment of a plant watering system of the present invention in accordance with the disclosed architecture;

FIG. 2 illustrates a side cross-sectional view of a container of one potential embodiment of a plant watering system of the present invention while placed in a soil while watering a plant in accordance with the disclosed architecture;

FIG. 3 illustrates a perspective view of a container and basket of one potential embodiment of a plant watering system of the present invention in accordance with the disclosed architecture;

FIG. 4 illustrates a flowchart of a method of using one potential embodiment of a plant watering system of the present invention in accordance with the disclosed architecture; and

FIG. 5 illustrates a flowchart of a method of using one potential embodiment of a plant watering system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved plant watering system. There also exists a long-felt need in the art for a plant watering system that eases the responsibility of plant owners. More specifically, there exists a long-felt need in the art for a plant watering system that allows a plant owner to water a plant over time without the need to water the plant on multiple occasions. There also exists a long-felt need in the art for a plant watering system that allows a plant owner to water a plant over time without the need to water the plant on multiple occasions wherein the system also ensures a plant has enough water in dry climates. In addition, there exists a long-felt need in the art for a plant watering system that allows a plant owner to water a plant over time without the need to water the plant on multiple occasions, wherein the system also ensures a plant has enough water in dry climates and prevents overwatering of the plant.

The present invention, in one exemplary embodiment, is comprised of a plant watering system. The system is comprised of a container used to water plants and at least two methods of using the container to water plants. During use, the system allows a user to water plants in a manner that does not require repeated manual watering over a short period of time.

The container is preferably made from a plastic (such as but not limited to BPA-free plastic), glass, or aluminum material and is also preferably transparent or semi-transparent to allow a user to see the liquid contents of the container while using the system. The container is preferably green to blend into a surrounding plant, but may be any color in the art in order to do so.

The container holds a liquid, such as but not limited to water, that is used to water a plant over an extended period of time. To allow a user to see how much water is placed into the container, the container may be comprised of at least one fill line. The fill line indicates how much water should be placed into the container. The container is also comprised of at least one spout that can be placed into soil at an angle that facilitates easy insertion of the spout into soil.

The container is received by at least one storage basket such that the container can be placed inside a freezer (to freeze the water inside the container). In one embodiment, the basket is comprised of at least one individual receiving area, such as but not limited to an opening, a recessed area, etc. that receives the container in a vertical position and prevents movement of the container.

The present invention is also comprised of a method of using the device. First, a device is provided comprised of a container comprised of a fill line. Then, the container can be filled with a liquid, such as but not limited to water, up to the fill line. Next, the container can be placed in a freezer (or frozen by any other means) until the liquid is frozen. In one embodiment, the container can be placed in the basket wherein the basket can then be placed into a freezer until the liquid is frozen. Then, the container can be removed and placed into a soil of a plant such that a spout of the container penetrates the soil at an angle between 0 and 180 degrees. As a result, the liquid inside the container will slowly unfreeze over time and melt into the soil to water the plant gradually in an autonomous manner.

The present invention is also comprised of a second method of using the device. First, a device is provided comprised of a container comprised of a fill line. Then, the container can be filled with a liquid, such as but not limited to water, up to (or below) the fill line. Then, at least one additive can be added to the liquid in the container. The additive aids in plant growth and may be comprised of, but is not limited to a water-soluble fertilizer, a liquid fertilizer, a seaweed extract, a fish emulsion, a compost tea, a humic acid, a fulvic acid, a bacteria, a mycorrhizae, a vermicompost leachate, a molasses, an Epsom salt (magnesium sulfate), a calcium solution, an iron chelate, a silicon solution, an amino acid, a proteins, a vitamin, an enzyme solution, or a pH adjuster. Next, the container can be placed in a freezer until the liquid is frozen (or otherwise freeze the liquid). In one embodiment, the container can be placed in the basket wherein the basket can then be placed into a freezer (or frozen by any other means) until the liquid is frozen. Then, the container can be removed and placed into a soil of a plant such that a spout of the container penetrates the soil at an angle between 0 and 180 degrees. As a result, the liquid and additive mix inside the container will slowly unfreeze over time and melt into the soil to water the plant gradually in an autonomous manner.

Accordingly, the plant watering system of the present invention is particularly advantageous as it provides an improved plant watering system. More specifically, the system eases the responsibility of plant owners by allowing a plant owner to water a plant over time without the need to water the plant on multiple occasions. Further, the system also ensures a plant has enough water in dry climates. In addition, the system prevents overwatering of the plant. In this manner, the plant watering system overcomes the limitations of existing plant watering devices, systems, and methods known in the art.

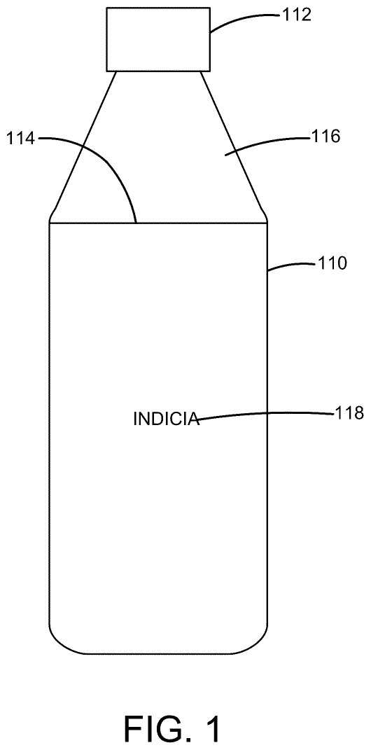

Referring initially to the drawings, FIG. 1 illustrates a side view of a container 110 of one potential embodiment of a plant watering system 100 of the present invention in accordance with the disclosed architecture. The system 100 is comprised of at least one container 110 used to water plants 12 and at least two methods 200,300 of using the container 110 to water plants. The system 100 allows a user to water plants in a manner that does not require repeated manual watering over a short period of time.

The container 110 is preferably made from a plastic (such as but not limited to BPA-free plastic), glass, or aluminum material. However, the container 110 may be made from any material in different embodiments. The container 110 is also preferably transparent or semi-transparent to allow a user to see the liquid 14 contents of the container 110 while using the system 100. The container 110 is preferably green to blend into a surrounding plant, but may be any color in the art in order to do so.

In addition, the container 110 may have at least one indicia 118. The indicia 118 may be in the form of a pattern, an image, a logo, an emblem, etc. In one embodiment, the indicia 118 resembles an animal (or a portion of an animal) to ward animals away from the plant 12. By way of example, in one embodiment the indicia 118 may resemble an owl to keep birds away from the plant 12. In another embodiment, the entire container 110 may be shaped like an entire (or a portion of) said animal.

The container 110 holds a liquid 14, such as but not limited to water, that is used to water a plant 12 over an extended period of time. To allow a user to see how much water 14 is placed into the container 110, the container 110 may be comprised of at least one fill line 114. The fill line 114 indicates how much water 14 should be placed into the container 110, wherein a user should not exceed the fill line 114 due to the expansion of the water 14 when it will be frozen in the methods 200,300 of use (as will be described more fully below.

In one embodiment, the container 110 is also comprised of a lid 112 that secures water 14 inside the container 110 and prevents spillage of the water 14. The lid 112 may be any type of container lid known in the art such as but not limited to a screw-on lid, a flip-top lid, a snap-on lid, a twist lock lid, a cork lid, a push down and turn lid, a slide lid, a tethered lid, a gasket seal lid, a dome lid, a recessed lid, a hinged lid, etc.

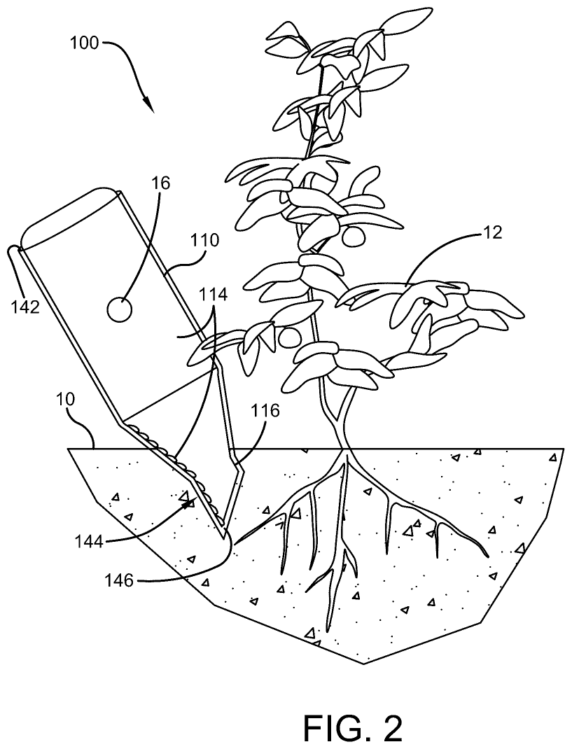

The container 110 is comprised of at least one spout 116 that can be placed into soil 10 at an angle. In one embodiment, the point 116 may be pointed. This embodiment facilitates easy insertion of the spout 116 into soil 10, as seen in FIG. 2. In one embodiment, the device 100 is comprised of at least one outer container 140. Said outer container 140 can be left permanently within soil 10 such that various frozen containers 110 can be placed into and removed from the container 140. This prevents a user from having to dig out the soil 10 each time to insert a new container 110. The outer container 140 may be comprised of any material known in the art. The outer container 140 is preferably comprised of an opening 142 that allows insertion of the container 110 into the outer container 140. The container 140 is also comprised of a spout 144 with at least one opening 146 that allows liquid from the container 110 to flow into the soil 10. The outer container 140 is preferably larger in size than the container 110 to facilitate easier insertion of the container 110 into the outer container 140. The container 140 may be any color in order to blend in or stand out from the soil 10.

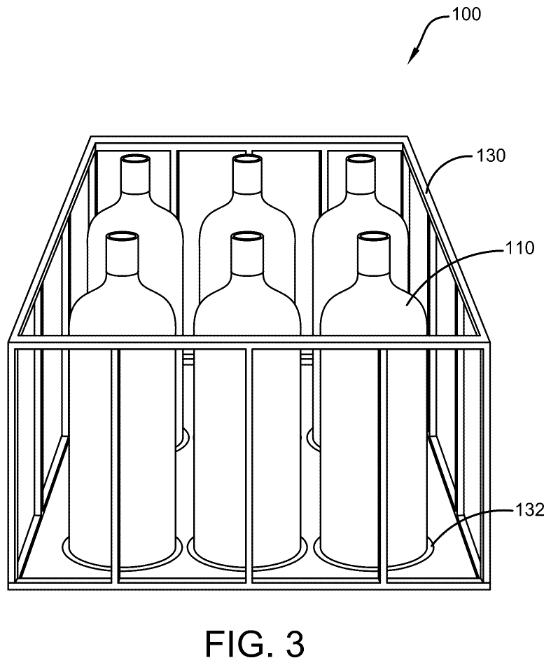

The container 110 is received by at least one storage basket 130, as seen in FIG. 3. The basket 130 may be any structure designed to receive the container 110 such that the container 110 can be placed inside a freezer (to freeze the water 14 inside the container). In one embodiment, the basket 130 is comprised of at least one individual receiving area 132, such as but not limited to an opening, a recessed area, etc. that receives the container 110 in a vertical position and prevents movement of the container 110.

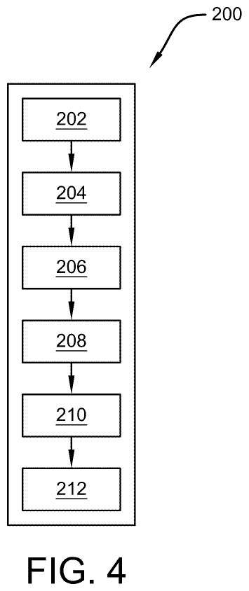

The present invention is also comprised of a method of using 200 the device 100, as seen in FIG. 4. First, a device 100 is provided comprised of a container 110 comprised of a fill line 114 [Step 202]. Then, the container 110 can be filled with a liquid 14, such as but not limited to water, up to the fill line 114 [Step 204]. Next, the container 110 can be placed in a freezer (or frozen by any other means) until the liquid 14 is frozen [Step 206]. In one embodiment, the container 110 can be placed in the basket 130 wherein the basket 130 can then be placed into a freezer until the liquid 14 is frozen [Step 208]. Next, an outer container 140 can be placed into the soil 10 such that the spout 144 of the container 140 is within the soil 10 at an angle between 0 and 180 degrees [Step 210]. Then, the container 110 can be removed and placed into the outer container 140 [Step 212]. As a result, the liquid 14 inside the container 110 will slowly unfreeze over time and melt into the soil 10 to water the plant 12 gradually in an autonomous manner.

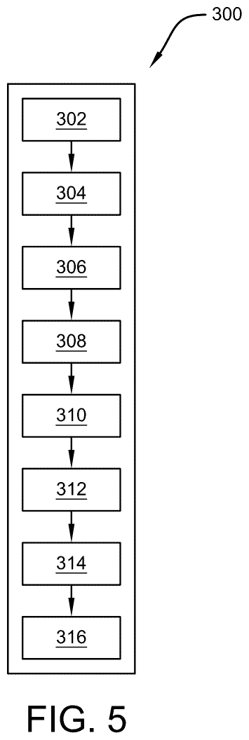

The present invention is also comprised of a second method of using 300 the device 100, as seen in FIG. 5. First, a device 100 is provided comprised of a container 110 comprised of a fill line 114 [Step 302]. Then, the container 110 can be filled with a liquid 14, such as but not limited to water, up to (or below) the fill line 114 [Step 304]. Then, at least one additive 16 can be added to the liquid 14 in the container [Step 306]. The additive aids in plant growth and may be comprised of, but is not limited to a water-soluble fertilizer, a liquid fertilizer, a seaweed extract, a fish emulsion, a compost tea, a humic acid, a fulvic acid, a bacteria, a mycorrhizae, a vermicompost leachate, a molasses, an Epsom salt (magnesium sulfate), a calcium solution, an iron chelate, a silicon solution, an amino acid, a proteins, a vitamin, an enzyme solution, or a pH adjuster. Next, the container 110 can be placed in a freezer until the liquid 14 is frozen (or otherwise freeze the liquid 14) [Step 308]. In one embodiment, the container 110 can be placed in the basket 130 wherein the basket 130 can then be placed into a freezer (or frozen by any other means) until the liquid 14 is frozen [Step 310]. Next, an outer container 140 can be placed into the soil 10 such that the spout 144 of the container 140 is within the soil 10 at an angle between 0 and 180 degrees [Step 312]. Then, the container 110 can be removed and placed into the outer container 140 [Step 314]. Therefore, the liquid 14 inside the container 110 will slowly unfreeze over time and melt into the soil 10 to water the plant 12 gradually in an autonomous manner. Then, the container 110 can be removed and placed into a soil 10 of a plant 12 such that a spout 116 of the container 110 penetrates the soil 10 at an angle between 0 and 180 degrees [Step 316]. As a result, the liquid 14 and additive 16 mix inside the container 110 will slowly unfreeze over time and melt into the soil 10 to water the plant 12 gradually in an autonomous manner.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plant watering system” and “system” are interchangeable and refer to the plant watering system 100 of the present invention.

Notwithstanding the forgoing, the plant watering system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plant watering system 100 as shown in the FIGS. are for illustrative purposes only, and that many other sizes and shapes of the plant watering system 100 are well within the scope of the present disclosure. Although the dimensions of the plant watering system 100 are important design parameters for user convenience, the plant watering system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant watering system comprising:
a container comprised of a fill line, a first spout comprised of a first opening, and a lid;
an outer container comprised of a first opening, and a second spout comprised of a second opening.

2. The plant watering system of claim 1, wherein the container is comprised of an indicia.

3. The plant watering system of claim 2, wherein the indicia resembles an animal or a portion of an animal.

4. The plant watering system of claim 1, wherein the container is shaped like an animal or a portion of an animal.

5. The plant watering system of claim 1, wherein the container is transparent or semi-transparent.

6. The plant watering system of claim 1, wherein the container is comprised of a BPA-free plastic.

7. The plant watering system of claim 1, wherein the container is positioned within the outer container.

8. The plant watering system of claim 1, wherein the lid is comprised of a screw-on lid, a flip-top lid, a snap-on lid, a twist lock lid, a cork lid, a push down and turn lid, a slide lid, a tethered lid, a gasket seal lid, a dome lid, a recessed lid, or a hinged lid.

9. The plant watering system of claim 1 further comprised of a basket.

10. The plant watering system of claim 9, wherein the basket is comprised of a receiving area for the container.

11. A method of using a plant watering system, the method comprising the following steps:
providing a plant watering system comprised of a container comprised of a fill line;
filling the container with water up to the fill line;
freezing the water within the container; and
placing the container in a soil of a plant at an angle between 0 and 180 degrees.

12. The plant watering system of claim 11, wherein the container is comprised of an indicia.

13. The plant watering system of claim 12, wherein the indicia resembles an animal or a portion of an animal.

14. The plant watering system of claim 11, wherein the container is shaped like an animal or a portion of an animal.

15. The plant watering system of claim 11, wherein the container is transparent or semi-transparent.

16. A method of using a plant watering system, the method comprising the following steps:
providing a plant watering system comprised of a container comprised of a fill line;
filling the container with water up to or below the fill line;
adding an additive to the water;
freezing the water within the container; and
placing the container in a soil of a plant at an angle between 0 and 180 degrees.

17. The method of using a plant watering system of claim 16, wherein the additive is comprised of a water-soluble fertilizer, a liquid fertilizer, a seaweed extract, a fish emulsion, a compost tea, a humic acid, a fulvic acid, a bacteria, a mycorrhizae, a vermicompost leachate, a molasses, an Epsom salt (magnesium sulfate), a calcium solution, an iron chelate, a silicon solution, an amino acid, a proteins, a vitamin, an enzyme solution, or a pH adjuster.

18. The plant watering system of claim 16, wherein the container is comprised of an indicia.

19. The plant watering system of claim 18, wherein the indicia resembles an animal or a portion of an animal.

20. The plant watering system of claim 18, wherein the container is shaped like an animal or a portion of an animal.
